(19) United States
(12) Patent Application Publication
(10) Pub. No.: US 2017/0171822 A1
(43) Pub. Date: Jun. 15, 2017

(54) Power Saving Method for Battery-powered Zigbee Devices

(71) Applicant: Wireless Input Technology, Inc., Wilmington (DE)

(72) Inventors: Xintian Li, Saratoga, CA (US); Gang Bi, Grayslake, IL (US)

(73) Assignee: Wireless Input Technology, Inc., Wilmington, DE (US)

(21) Appl. No.: 14/964,583

(22) Filed: Dec. 10, 2015

(51) Int. Cl. H04W 52/02

(52) U.S. Cl. CPC H04W 52/0254; H04W 52/0229

(57) ABSTRACT

This invention discloses a power saving method for battery-powered Zigbee devices. Under normal circumstances, a Zigbee device keeps its RF module in sleep mode. Only when the Zigbee device receives a signal generated in response to a sensor triggering event, a user input, or a prescheduled event, would the Zigbee device wake up its RF module to communicate with a Zigbee coordinator. As such, the Zigbee device does not need to always listen to the Beacon signals periodically broadcasted by the Zigbee coordinator, therefore saving a lot of battery power.

### FIELD OF INVENTION

This invention generally relates to Zigbee technology. More specifically, this invention relates to saving power for battery-powered Zigbee devices.

### BACKGROUND OF THE INVENTION

Zigbee is one of several widely used Wireless Personal Area Network (WPAN) technologies. It has been standardized in IEEE 802.15.4 as a wireless network standard for smart home networks (e.g., home automation and security systems) because of its low power consumption and low cost compared with other WPAN technologies such as Bluetooth and Infrared Data Association (IrDA).

Zigbee-based home automation and security systems allow home owners to remotely monitor their homes, receive security alerts, and control the various devices and/or appliances connected by Zigbee networks from mobile devices (e.g., smartphones). Thus, they are gaining popularity among consumers. Such a home automation and security system usually includes one or more battery-powered devices equipped with sensors for home security protection. Traditionally, such devices need to constantly listen to the Beacon signals periodically broadcasted by a coordinator of the Zigbee network. The Zigbee coordinator may also function as a gateway bridging the Zigbee network and external networks. If a device loses connection with the Zigbee coordinator—as a result of a power outage, for example—the device will immediately start searching for and reconnect with the Zigbee coordinator to make sure it is always in connection with the Zigbee coordinator. In case there is a triggering event detected by a sensor of the device (e.g., opening/closing of a door/window, motion detection of a human or animal), the device can send data packet(s) to the Zigbee coordinator to report the event.

However, the above described traditional approach has drawbacks. First, it is very energy consuming for battery-powered devices to constantly listen to and/or communicate with the Zigbee coordinator. Second, when the Zigbee coordinator is powered down during a long power outage, the devices will continuously search for the Zigbee coordinator without stopping, thus draining their battery power very quickly. As a result, consumers may frequently need to replace the batteries of these devices.

Thus, a new mechanism is needed for battery powered devices in a Zigbee network to conserve battery power.

### SUMMARY OF THE INVENTION

In one embodiment of the present invention, a Zigbee network includes one or more battery-powered Zigbee end devices (or Zigbee devices), a Zigbee coordinator, and one or more Zigbee router devices. The battery-powered Zigbee devices may include one or more door/window magnetic sensor devices, infrared motion sensor devices, remote controllers, garage door openers, flood detection devices, and other end devices. Under normal situations, these battery-powered Zigbee devices keep their radio frequency (RF) modules, which provide wireless communication functions for the devices, in sleep mode to conserve battery power. They wake up their RF modules to communicate with the Zigbee coordinator only when there is a sensor triggering event (e.g., opening/closing of a door/window, motion detection of a human or animal, or detection of flooding), a user input (e.g., press a button on the remote controller), or a previously scheduled event. If the communication fails because the Zigbee devices have lost connection with the Zigbee coordinator—as a result of a power outage, for example—they will search for and rejoin the Zigbee coordinator and communicate again.

In another embodiment of the present invention, a Zigbee device keeps its RF module in sleep mode but wakes up the RF module to check whether it is still in connection with the Zigbee coordinator according to a preset schedule. The schedule may include one or more events and may be created based on past operation data of the Zigbee network and its devices. At such a prescheduled event, if the Zigbee device determines that it has lost connection with the Zigbee gateway/coordinator—as a result of an intervening event such as a power outage, for example—it will reestablish the connection. For example, the system may find that in 90% of the times a user opened the garage door between 8 AM and 8:30 AM on weekdays based on the user's previous use data of the garage door opener (which is reflected from the past operation data of the garage door opener). Based on this use pattern, the system can set a schedule to cause the garage door opener to check whether it is in connection with the Zigbee coordinator at 7 AM on every weekday. If the connection is lost the Zigbee device will reestablish the connection so that when the user tries to open the garage door later that day, there will be no noticeable delay.

In yet another embodiment of the present invention, a Zigbee device searches for a Zigbee coordinator to connect with. If the search fails, the Zigbee device waits for a period of time before conducting another search (the “wait-and-search process”). The Zigbee device may repeat the wait-and-search process until it finds the Zigbee coordinator. Also, the waiting period between two adjacent searches may become incrementally longer or changes according to a particular pattern created based on past operation data of the Zigbee coordinator.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a system diagram illustrating a Zigbee network according to some embodiments of the present invention.

FIG. 2 is a block diagram of a Zigbee device according to some embodiments of the present invention.

FIG. 3 is a functional block diagram of a cloud server according to some embodiments of the present invention.

FIG. 4 is a diagram illustrating the interaction between a Zigbee device and a Zigbee gateway/coordinator according to some embodiments of the present invention.

FIG. 5 is a flow diagram illustrating a process of sending a data packet regarding a sensor triggering event, a user input, or a previously scheduled event from a Zigbee device to a Zigbee gateway/coordinator according to some embodiments of the present invention.

FIG. 6 is a flow diagram illustrating a process of searching for a Zigbee gateway/coordinator according to some embodiments of the present invention.

### DETAILED DESCRIPTION

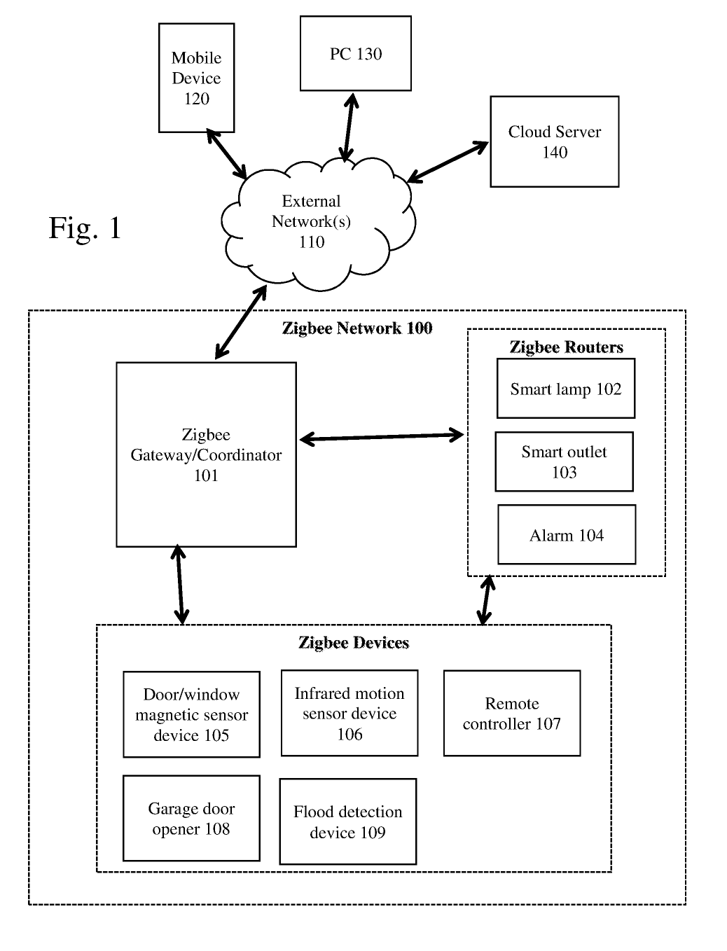

FIG. 1 is a system diagram showing a Zigbee network 100. As shown, the Zigbee network 100 includes a Zigbee gateway/coordinator 101, one or more Zigbee routers, including but not limited to a smart lamp 102, a smart outlet 103, and an alarm 104, and one or more Zigbee devices, including but not limited to a door/window magnetic sensor device 105, an infrared motion sensor device 106, a remote controller 107, a garage door opener 108, and a flood detection device 109. Although not shown in the figure, the Zigbee network 100 may include additional Zigbee devices and/or Zigbee routers.

In one embodiment, the Zigbee gateway/coordinator 101 functions as the coordinator as well as the gateway of the Zigbee network 100. As a coordinator, it establishes the Zigbee network 100, stores information about the network such as security keys, and forward data packets. As a gateway, it serves as a bridge between the Zigbee network 100 and external network(s) 110 and handles the data traffic coming into or going out of the Zigbee network 100. The Zigbee gateway/coordinator 101 is typically powered by 110 v/220 v external power source due to high power consumption. In another embodiment, the Zigbee network 100 may have two separate machines—one functions as the gateway and the other functions as the coordinator.

The smart lamp 102, smart outlet 103, and alarm 104 are routers of the Zigbee network 100. They act as intermediate nodes, extending the network by relaying data from other devices. They are typically powered by 110 v/220 v external power source and do not go into sleep.

The door/window magnetic sensor device 105, infrared motion sensor device 106, garage door opener 108, and flood detection device 109 are typically battery-powered devices. Each of these devices has a sensor for detecting a sensor triggering event. For example, a sensor triggering event for the door/window magnetic sensor device 105 may be the opening or closing of the door or window; a sensor triggering event for the infrared motion sensor device 106 may be a human or animal moving within a certain spatial range near the device; and a sensor triggering event for the flood detection device 109 may be that water has submerged the sensor of the device. In one embodiment, the RF module of each of these devices stays in sleep mode under normal circumstances. Only when its sensor detects a sensor triggering event would the device's RF module wakes up from the sleep mode to communicate with the Zigbee gateway/coordinator. As shown in FIG. 1, a Zigbee device can communicate with the Zigbee gateway/coordinator 101 directly or through one or more Zigbee routers.

The remote controller 107 provides functions for controlling various other Zigbee devices and routers, such as turning on/off the smart lamp 102, turning on/off the garage door opener 108 to open/close the garage door, etc. It is also typically battery-powered. The remote controller 107 has a user input interface such as a touchscreen or keypad for receiving commands. In one embodiment, the RF module of the remote controller 107 stays in sleep mode under normal circumstances. Only when a user makes a user input would the remote controller 107 wakes up its RF module from the sleep mode to communicate with the Zigbee gateway/coordinator.

Also as shown in FIG. 1, the Zigbee network 100 may be remotely monitored and/or controlled by a mobile device 120 or a personal computer (PC) 130 via the external network(s) 110, which may include wired or wireless, local or wide area network(s) (e.g., Wi-Fi, Ethernet, Internet). In one embodiment, a user may configure the mobile device 120 (e.g., a smartphone, tablet computer) or the PC 130 to receive security alerts sent from the Zigbee network 100 and to control the various Zigbee devices and routers in his house. In the event of a burglar breaking into his house through a window, the door/window magnetic sensor device 105 attached to the window wakes up its RF module and sends a data packet to the Zigbee gateway/coordinator 101, which then sends an alert message to the mobile device 120 or PC 130 via the external network(s) 110. Meanwhile, the Zigbee gateway/coordinator 101 may activate the alarm 104 to scare off the burglar.

In another embodiment, the mobile device 120 and PC 130 may communicate with the Zigbee network 100 via a cloud server 140, which may offload certain responsibilities from the mobile device 120, the PC 130, and/or the Zigbee network 100. In addition, the cloud server 140 may integrate various other services and functions, including but not limited to account management, access control, software/firmware upgrade, data storage, and data security. Users can even choose which cloud server to use based on their geographical locations.

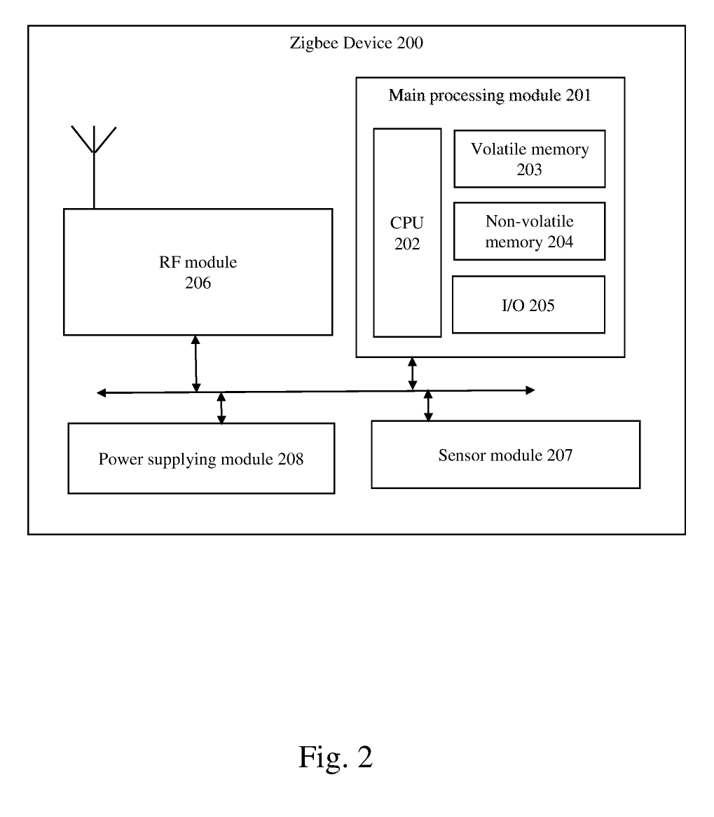

FIG. 2 is a block diagram of a Zigbee device 200. In one embodiment, the Zigbee device 200 includes a main processing module 201, an RF module 206, a sensor module 207, and a power supplying module 208. The main processing module 201 includes a central processing unit (CPU) 202, a volatile memory 203, a non-volatile memory 204, and an input/output (I/O) component 205. These components communicate over the one or more communication buses or signal lines. Although not shown in FIG. 2, the Zigbee device 200 is powered by a battery source. It should be appreciated that the Zigbee device 200 is only one example of a Zigbee device, and that the Zigbee device 200 may have more or fewer components than shown, or a different configuration of components. The various components shown in FIG. 2 may be implemented in hardware, software or a combination of both hardware and software on a single semiconductor chip or multiple chips.

The volatile memory 203 may include one or more static RAM (SRAM) or dynamic RAM (DRAM) modules. Access to the volatile memory 203 by other components of the Zigbee device 200 may be controlled by the CPU 202 or a RAM controller (not shown in FIG. 2). The non-volatile memory 204 may include one or more magnetic disk storage devices, flash memory devices, or other non-volatile solid state memory devices. Access to the non-volatile memory 204 may be controlled by the CPU 202 or a non-volatile memory controller (not shown in FIG. 2). The CPU 202 runs various software programs and/or sets of instructions stored in the volatile memory 203 to perform various functions for the Zigbee device 200 and to process data.

The I/O component 205 is an optional component for certain Zigbee devices. It may include a touchscreen, a keypad, and/or a speaker. In one embodiment, the door/window magnetic sensor device 105, the infrared motion sensor device 106, the garage door opener 108, and the flood detection device 109 may not have such an I/O component 205. The I/O component 205 may be controlled by the CPU 202 or an I/O controller (not shown in FIG. 2).

The RF module 206 receives and sends electromagnetic waves. The RF module 206 converts electrical signals to/from electromagnetic waves and communicates with the Zigbee gateway/coordinator 101 and the Zigbee routers via the electromagnetic waves. The RF module 206 may include circuitry for performing these functions, including but not limited to an antenna system, an RF transceiver, one or more amplifiers, a tuner, one or more oscillators, a digital signal processor, memory, and so forth.

The sensor module 207 includes one or more sensors for detecting sensor triggering events. For example, the magnetic sensor of the door/window magnetic sensor device 105 can detect the opening or closing of a door or window; the infrared sensor of the infrared motion sensor device 106 can detect motions near the device; the sensor of the garage door opener can detect a signal from a remote controller, and the water detecting sensor of the flood detection device 109 can detect the presence of water, indicating that a flood may have occurred.

The power supplying module 208 provides the power supplying function for the Zigbee device 200. It may be controlled by a power management program running in the main processing unit 201. In one embodiment, a Zigbee device 200 has two different operating modes—the power-conserving mode and the active operating mode. In addition, the RF module of a Zigbee device has two different operating modes—the sleep mode and the active mode. When the Zigbee device 200 is in the power-conserving mode, the power supplying module 208 cuts off power supply to the RF module 206, causing the RF module 206 to sleep. When the sensor module 207 detects a sensor triggering event or the I/O component 205 receives a user input, the power supplying module 208 resumes power supply to the RF module 206, waking up the RF module 206 and causing the Zigbee device 200 enter into the active operating mode.

In another embodiment, the operating mode of the Zigbee device 200 may be affected by a scheduling program running in the main processing module 201. This scheduling program may cause the Zigbee device 200 to switch to the active operating mode according to a preset schedule (e.g., 7 AM on each weekday) to check whether the device is still in connection with a Zigbee gateway/coordinator. If the connection is still alive, the Zigbee device 200 goes back to the power-conserving mode immediately. Otherwise, the Zigbee device 200 searches for and rejoins the Zigbee gateway/coordinator, and then goes back to the power-conserving mode. This approach prevents any potential delay caused by reconnecting the Zigbee device and the Zigbee gateway/coordinator when a sensor triggering event or user input occurs. The particular schedule may be set by a user through a mobile device remotely or set by a smart program residing on the cloud server 140 which determines the schedule based on past operation data of a Zigbee network and its device.

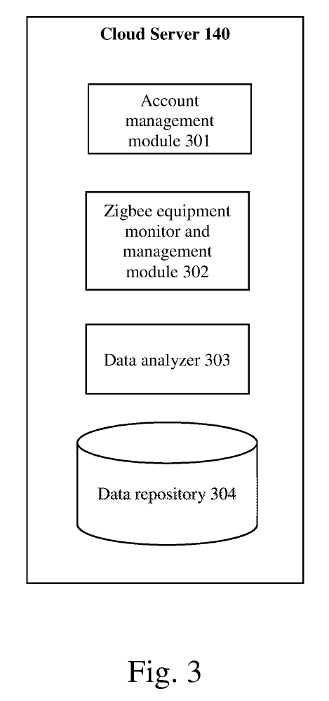

FIG. 3 is a functional block diagram of a cloud server 140. In one embodiment, the cloud server 140 includes an account management module 301, a Zigbee equipment monitor and management module 302, a data analyzer 303, and a data repository 304. Although it is shown as a single box in FIG. 3, the cloud server 140 may be implemented on one server machine or multiple server machines. The various modules or components of the cloud server 140 may be implemented by software, hardware, or a combine of software and hardware.

The account management module 301 provides the function for managing user account information, including but not limited to user profile, subscription, and billing. The Zigbee equipment monitor and management module 302 provides various functions for a user to monitor and manage the Zigbee network and its various devices. For example, through the Zigbee equipment monitor and management module 302, a user can check whether the Zigbee gateway/coordinator 101, any Zigbee router, or any Zigbee device in the network is currently online, set a wake-up schedule for any particular Zigbee device, or turn on/off any particular Zigbee device or router such as the smart lamp 102 shown in FIG. 1. A user can access the account management module 301 and the Zigbee equipment monitor and management module 302 from a mobile device or a personal computer remotely.

The data repository 304 stores the user account information described above. It may also store the operation log of a Zigbee network and its devices. The operation log may include data regarding when, why, and how long the Zigbee network or any device was offline, any triggering event occurred in the past, and any user interaction with a device. The data analyzer 303 analyzes these data to find any useful pattern that can be helpful to improve user experience. For example, if the data analyzer 303 finds from the past operation data of the garage door opener that in 90% of the times during the past 5 years a user opened his garage door between 8 AM and 8:30 AM on the weekdays, the cloud server 140 could set the garage door opener to check its connection with the Zigbee gateway/coordinator every weekday at 7:50 AM.

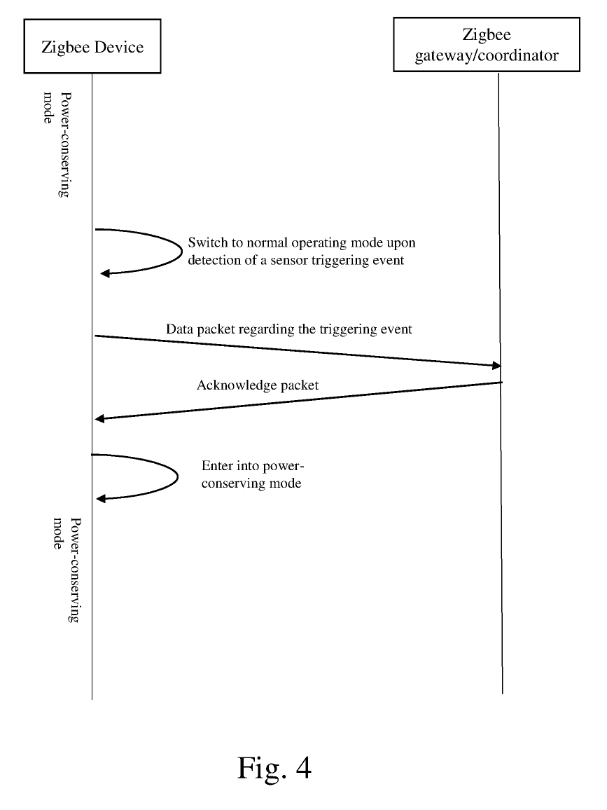

FIG. 4 is a diagram illustrating the interaction between a Zigbee device and a Zigbee gateway/coordinator. In one embodiment, the Zigbee device normally operates in the power-conserving mode. When its sensor detects a sensor triggering event, the Zigbee device switches to the active operating mode. The Zigbee device sends a data packet regarding the sensor triggering event to the Zigbee gateway/coordinator. If the transmission is successful, the Zigbee gateway/coordinator sends an acknowledge packet back to the Zigbee device. After receiving the acknowledge packet from the Zigbee gateway/coordinator, the Zigbee device goes back to the power-conserving mode unless there is further action needs to be done.

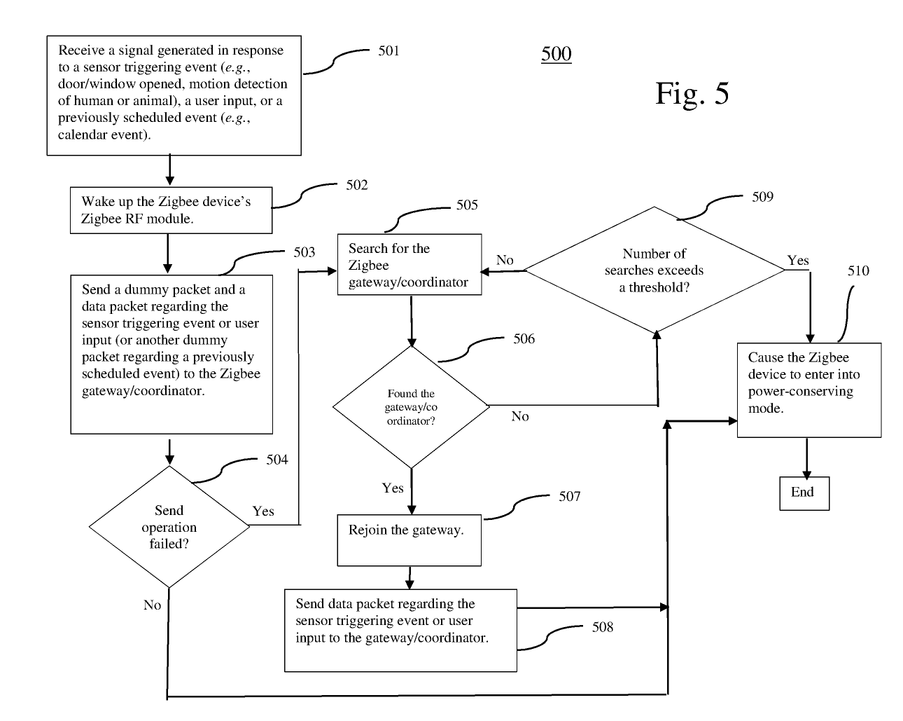

FIG. 5 is a flow diagram illustrating a process 500 of sending data packet(s) regarding a sensor triggering event, a user input, or a previously scheduled event to the Zigbee gateway/coordinator to which the device was connected. In one embodiment, the process 500 is executed by the main processing module of a Zigbee device.

At step 501, the process 500 receives a signal generated in response to (1) a sensor triggering event, (2) a user input, or (3) a previously scheduled event.

Sensor triggering events concern Zigbee devices having sensors. For example, when someone opens or closes a door equipped with a door/window magnetic sensor device, the event (or action) would trigger the magnetic sensor of device. The sensor module of the device then generates a signal in response to the event and sends the signal to the process 500 that is running in the main processing module of the device. Other sensor triggering events include but are not limited to: a human or animal moves within a certain spatial range near an infrared motion sensor device; water submerges the sensor of a flood detection device; a signal from a control device that tells a garage door opener to open the garage door.

User inputs concern Zigbee devices with I/0 components. For example, when a user pushes a button or key on a remote controller, the touchscreen or keypad of the remote controller generates a signal in response to the user input and sends the signal to the process 500.

As discussed above, the operating mode of a Zigbee device may be affected by a scheduling program running in the main processing module of the device. This scheduling program may cause the Zigbee device to switch to the active operating mode according to a preset schedule (e.g., at a particular time on each weekday) to check whether the Zigbee device is still in connection with the Zigbee gateway/coordinator. In response to such a previously scheduled event, the scheduling program generates a signal and sends the signal to the process 500.

At step 502, the process 500 wakes up the Zigbee device's RF module. For example, the process 500 may call a subroutine of the power management program to instruct the power supplying module of the Zigbee device to resume power supply to the RF module.

At step 503, the process 500 sends, through the RF module, a data packet regarding the sensor triggering event or user input to the Zigbee gateway/coordinator. In case of a previously scheduled event, the process 500 may send a dummy packet instead. Then, at step 504, the process 500 determines whether the send operation has failed. Under the Zigbee standard, an end device will automatically try up to eight (8) times in sending a data packet to the gateway/coordinator if the previous one fails. If there are sixteen (16) successive send failures, the end device will receive an error. In one embodiment, to take advantage of the Zigbee standard, the process 500 successively sends a dummy packet and the actual data packet (or another dummy packet in case of a prescheduled event) to the Zigbee gateway/coordinator.

If the process 500 determines that the send operation succeeded at step 504, the process goes to step 510, where it causes the Zigbee device to enter into power-conserving mode before it ends. Otherwise, the process goes to step 505 where it searches for the Zigbee gateway/coordinator.

At step 506, the process 500 determines whether it found the Zigbee gateway/coordinator. If so, at step 507, the process 500 calls a subroutine to rejoin the Zigbee gateway/coordinator. Then, the process 500 goes to step 508 where it sends the data packet regarding the sensor triggering event or user input to the Zigbee gateway/coordinator. From step 508, the process 500 goes to step 510.

If the process 500 did not find the Zigbee gateway/coordinator, it goes to step 509 from step 506. At step 509, the process 500 determines whether the number of searches for the Zigbee gateway/coordinator has exceeded a threshold (e.g., 5 times). If not, the process 500 goes to step 505 again to search for the Zigbee gateway/coordinator. If yes, the process 500 goes to step 510.

At step 510, the process 500 causes the end device to enter into the power-conserving mode. For example, the process 500 may call another subroutine of the power management program to instruct the power supplying module of the Zigbee device to cut off power supply to the RF module, causing the RF module to sleep. Afterwards, the process 500 ends.

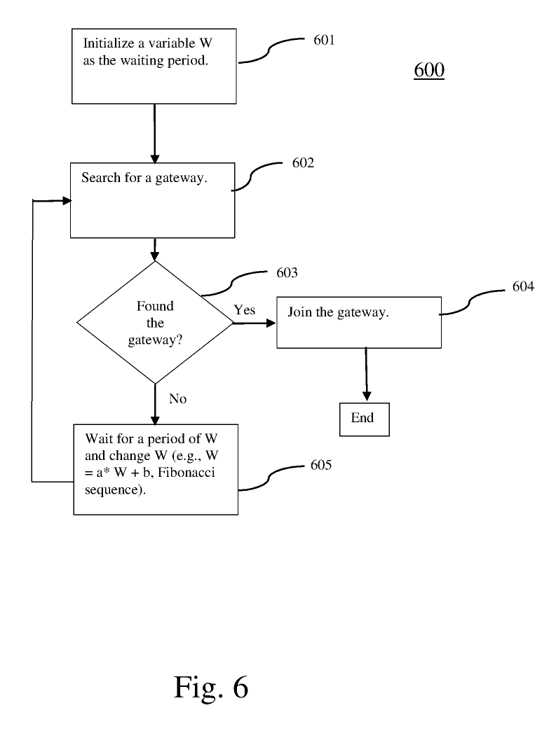

FIG. 6 is a flow diagram illustrating a process 600 of searching for a Zigbee gateway/coordinator. In one embodiment, the process 600 runs in the main processing module of a Zigbee device. It is executed when the Zigbee device determines that its connection with the Zigbee gateway/coordinator has lost.

At step 601, the process 600 initializes a variable Was the waiting period (e.g., 1 second, 5 seconds) before conducting a subsequent search for the Zigbee gateway/coordinator if a search fails.

At step 602, the process 600 searches for the Zigbee gateway/coordinator.

At step 603, the process 600 determines whether it found the Zigbee gateway/coordinator. If so, the process 600 goes to step 604, where it calls a subroutine to rejoin the Zigbee gateway/coordinator. Otherwise, the process 600 goes to step 605.

At step 605, the process 600 waits for a period of time measured by the variable W. The process 600 then changes W so that when the next search for the Zigbee gateway/coordinator fails, the process 600 will wait for a different time period before conducting a subsequent search. Various linear functions or non-linear functions may be used for changing the variable W. For example, a linear function may be W=a*W+b, wherein a and b are constants. As another example, the Fibonacci sequence [0, 1, 1, 2, 3, 5, 8, 13, 21, 34 . . . ] or any other sequence (e.g., [15 s, 30 s, 1 min, 5 min, 15 min, 30 min, 60 min, 2 hours, 4 hours, 8 hours, 24 hours]) may be used for selecting the next waiting period W. In these examples, the value of W incrementally increases so that the Zigbee device waits longer and longer before conducting a subsequent search. Alternatively, the value of W may also decrease at a certain point or change according to a particular pattern. The pattern may be created based on past operation data of the Zigbee gateway/coordinator. For example, by analyzing data regarding all previous cases where the Zigbee gateway/coordinator was offline, a pattern may be found as follows: 95% of the cases may be divided into several groups: in the first group the Zigbee gateway/coordinator was offline for a time period between 1 second and 5 seconds, in the second group the offline period was between 30 seconds and 40 seconds, in the third group the offline period was between 1 minute and 2 minutes, and in the fourth group the offline period was between 30 minutes and 40 minutes. Thus, based on this pattern, searches should be conducted within the following ranges: 1-5 seconds, 30-40 seconds, 1-2 minutes, and 30-40 minutes because the Zigbee gateway/coordinator is less likely to be back online outside these ranges.

In one embodiment, if W exceeds a predetermined value (e.g., 30 seconds), the process 600 causes the RF module of the Zigbee device enter into the sleep mode during the waiting period and wakes up the RF module right before the next search, thus conserving battery power of the Zigbee device. This is especially the case when the Zigbee gateway/coordinator is down due to a prolonged power outage. Without the mechanism provided by the process 600, the Zigbee device's RF module would continuously search for the Zigbee gateway/coordinator without stopping, draining the Zigbee device's battery power very quickly.

It should be noted that the process 600 is different from step 505 of the process 500. Step 505 involves a single search for a Zigbee gateway/coordinator (although it may be invoked multiple times to achieve multiple searches), whereas the process 600 involves a series of searches for a Zigbee gateway/coordinator. Also, the process 600 may be implemented on a Zigbee device that does not have the process 500 implemented.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A method for saving battery power of a Zigbee device, the method comprising:
keeping an RF module of the Zigbee device to stay in a sleep mode;
in response to receiving a signal generated in response to a sensor triggering event, waking up the RF module;
sending a data packet regarding the triggering event to a Zigbee coordinator; and
causing the RF module of the Zigbee device to go back to the sleep mode.

2. The method of claim 1 further comprising if the sending step fails, searching for and rejoining the Zigbee coordinator and resending the data packet.

3. The method of claim 2 further comprising sending a dummy packet to the Zigbee coordinator before sending the data packet.

4. The method of claim 1, wherein the Zigbee coordinator is also a gateway.

5. The method of claim 1, wherein the Zigbee device has a magnetic sensor and the sensor triggering event is one of closing a window, closing a door, opening the window, and opening the door.

6. The method of claim 1, wherein the Zigbee device has an infrared motion sensor and the sensor triggering event is one of a human moving within a certain spatial range of the Zigbee device and an animal moving within the certain spatial range of the Zigbee device.

7. The method of claim 1, wherein the Zigbee device has a water detecting sensor and the sensor triggering event is the water detecting sensor being submerged by water.

8. A method for saving battery power of a Zigbee device, the method comprising:
keeping an RF module of the Zigbee device in a sleep mode;
in response to receiving a signal generated in response to a user input, waking up the RF module;
sending a data packet regarding the user input to a Zigbee coordinator; and
causing the RF module of the Zigbee device to go back to the sleep mode.

9. The method of claim 8 further comprising if the sending step fails, searching for and rejoining the Zigbee coordinator and resending the data packet.

10. The method of claim 9 further comprising sending a dummy packet to the Zigbee coordinator before sending the data packet.

11. The method of claim 8, wherein the user input is received on a touchscreen of the Zigbee device.

12. The method of claim 8, wherein the user input is received on a keypad of the Zigbee device.

13. A method for saving battery power of a Zigbee device, the method comprising:
maintaining an RF module of the Zigbee device to be in a first state where the RF module does not have power;
in response to receiving a signal generated in response to a prescheduled event, supplying power to the RF module so that the RF module enters into a second state;
determining whether the Zigbee device has lost connection with a Zigbee coordinator;
in response to the determination that the connection has lost, searching for and rejoining the Zigbee coordinator; and
stopping supplying power to the RF module so that the RF module goes back to the first state.

14. The method of claim 13, wherein the prescheduled event is determined based on past operation data of the Zigbee device.

15. The method of claim 13, wherein the determining step comprises successively sending two dummy packets to the Zigbee coordinator.

16. A Zigbee device comprising:
an RF module for communicating with a Zigbee coordinator;
a sensor;
a memory for storing instructions; and
a processor which, upon executing the instructions, performs a process comprising:
keeping the RF module in a sleep mode;
in response to receiving a signal generated in response to the sensor's detection of a sensor triggering event, waking up the RF module;
sending a data packet regarding the triggering event to the Zigbee coordinator; and
causing the RF module to go back to the sleep mode.

17. The Zigbee device of claim 16, wherein the process further comprises if the sending step fails, searching for and rejoining the Zigbee coordinator and resending the data packet.

18. The Zigbee device of claim 17, wherein the process further comprises sending a dummy packet to the Zigbee coordinator before sending the data packet.

19. The Zigbee device of claim 16 further comprising a power supplying module which can supply or stop supplying power to the RF module.

20. A Zigbee device comprising:
an RF module for communicating with a Zigbee coordinator;
a power supplying module;
an input component for receiving user inputs;
a memory for storing instructions; and
a processor which, upon executing the instructions, performs a process comprising:
maintaining the RF module to be in a first state where the RF module does not have power;
in response to receiving a signal generated in response to a user input, causing the power supplying module to supply power to the RF module so that the RF module enters into a second state;
sending a data packet regarding the user input to the Zigbee coordinator;
if the sending step fails, searching for and rejoining the Zigbee coordinator and resending the data packet; and
causing the power supplying module to stop supplying power to the RF module so that the RF module goes back to the first state.

21. The Zigbee device of claim 20, wherein the process further comprises sending a dummy packet to the Zigbee coordinator before sending the data packet.

22. The Zigbee device of claim 20, wherein the input component comprises one of a touchscreen and a keypad.

23. A Zigbee device comprising:
an RF module for communicating with a Zigbee coordinator;
a memory for storing instructions; and
a processor which, upon executing the instructions, performs a process comprising:
keeping the RF module to stay in a sleep mode;
in response to receiving a signal generated in response to a prescheduled event, waking up the RF module;
determining whether the Zigbee device has lost connection with the Zigbee coordinator;
in response to the determination that the connection has lost, searching for and rejoining the Zigbee coordinator; and
causing the RF module of the Zigbee device to go back to the sleep mode.

24. The Zigbee device of claim 23, wherein the prescheduled event is determined based on past operation data of the Zigbee device.

25. The Zigbee device of claim 23, wherein the determining step comprises successively sending two dummy packets to the Zigbee coordinator.

26. A non-transient computer readable medium programmed with computer readable code that upon execution by a processor of a Zigbee device causes the processor to:
maintain an RF module of the Zigbee device to be in a first state where the RF module does not have power;
in response to receiving a signal generated in response to a sensor triggering event, supply power to the RF module so that the RF module enters into a second state;
send a data packet regarding the sensor triggering event to a Zigbee coordinator; and
stop supplying power to the RF module so that the RF module goes back to the first state.

27. The non-transient computer readable medium of claim 26, wherein execution by the processor further causes the processor to:
search for and rejoin the Zigbee coordinator if the send step fails; and
resend the data packet.

28. A non-transient computer readable medium programmed with computer readable code that upon execution by a processor of a Zigbee device causes the processor to:
keep an RF module of the Zigbee device to stay in a sleep mode;
in response to receiving a signal generated in response to a user input, wake up the RF module;
send a data packet regarding the user input to a Zigbee coordinator; and
cause the RF module of the Zigbee device to go back to the sleep mode.

29. A non-transient computer readable medium programmed with computer readable code that upon execution by a processor of a Zigbee device causes the processor to:
keep an RF module of the Zigbee device in a sleep mode;
in response to receiving a signal generated in response to a prescheduled event, wake up the RF module;
determine whether the Zigbee device has lost connection with a Zigbee coordinator;
in response to the determination that the connection has lost, search for and rejoin the Zigbee coordinator; and
cause the RF module of the Zigbee device to go back to the sleep mode.

30. The non-transient computer readable medium of claim 29, wherein the prescheduled event is determined based on past operation data of the Zigbee device.
